(19) United States
(12) Patent Application Publication
(10) Pub. No.: US 2020/0367544 A1
(43) Pub. Date: Nov. 26, 2020

(54) HEATING-ODOR-SUPPRESSING AGENT FOR COOKING OIL OR FAT COMPOSITION, METHOD FOR SUPPRESSING HEATING ODOR IN COOKING OIL OR FAT COMPOSITION, AND METHOD FOR PRODUCING COOKING OIL OR FAT COMPOSITION

(71) Applicant: J-OIL MILLS, Inc., Tokyo (JP)

(72) Inventors: Takehiko SEKIGUCHI, Tokyo (JP); Jun IMAGI, Tokyo (JP); Anna ASAKURA, Tokyo (JP); Ayato TAKASAKI, Tokyo (JP); Kenichi WATANABE, Tokyo (JP)

(21) Appl. No.: 16/635,186

(22) PCT Filed: Jun. 1, 2018
(86) PCT No.: PCT/JP2018/021195

§ 371 Date: Jan. 30, 2020

(30) Foreign Application Priority Data
Aug. 8, 2017 (JP) 2017-153489

(51) Int. Cl. A23L 29/00; A23D 9/04; A23L 5/10

(52) U.S. Cl. CPC A23L 29/035; A23L 5/11; A23D 9/04

(57) ABSTRACT

Provided are a heating-odor-suppressing agent for a cooking oil or fat composition, a method for suppressing a heating odor in a cooking oil or fat composition, and a method for producing the cooking oil or fat composition that make it possible to suppress the heating odor of an oil or fat produced during cooking of deep-fried foods or the like.

The heating-odor-suppressing agent for a cooking oil or fat composition contains corn-derived roasted oil as an active component. Moreover, the method for suppressing a heating odor in a cooking oil or fat composition involves including corn-derived roasted oil in the cooking oil or fat composition. Furthermore, the method for producing a cooking oil or fat composition comprises mixing corn-derived roasted oil and an edible oil or fat other than the roasted oil to thereby obtain an oil or fat composition that contains 0.01% by mass or more to 10% by mass or less of the roasted oil.

### TECHNICAL FIELD

The present invention relates to a heating-odor-suppressing agent for a cooking oil or fat composition, a method for suppressing a heating odor in a cooking oil or fat composition, and a method for producing a cooking oil or fat composition that are used in cooking deep-fried foods, tempura, and other fried foods, as well as stir-fried foods, grilled foods, and other such foods.

### BACKGROUND ART

Rapeseed oil, corn oil, soybean oil, sesame oil, palm oil, and other such edible oils or fats are used in the cooking of deep-fried foods, tempura, and other fried foods, as well as stir-fried foods, grilled foods, and other such foods. However, in some situations, these oils or fats produce a pungent heating odor during cooking, and a problem is therefore created in that the heating odor is unpleasant for consumers.

However, roasted oil is provided with an appetizing flavor by the roasting of raw oil ingredients, and the roasted oil is mixed with rapeseed oil, corn oil, soybean oil, sesame oil, palm oil, and other such edible oils or fats, and is used as a flavoring for various types of foods. It is also reported in Patent Documents 1 and 2 that roasted oils have an effect in reducing the raw odor and/or off-odor (heating-induced degradation odor) that is characteristic of soybean oil or the like.

### RELATED ART DOCUMENTS

### Patent Documents

[Patent Document 1] Japanese Laid-open Patent Application No. 2006-204266

[Patent Document 2] international Publication No. 2009/028483

### DISCLOSURE OF THE INVENTION

### Problems to be Solved by the Invention

However, in Patent Documents 1 and 2, the roasted oil has soybeans, sesame, rapeseeds, or the like as raw ingredients, and it was difficult to assert that the suppression effect of the roasted oil on odors during cooking was sufficient.

An object of the present invention is therefore to provide, by using a roasted oil having corn as a raw ingredient, a heating-odor-suppressing agent for a cooking oil or fat composition, a method for suppressing a heating odor in a cooking oil or fat composition, and a method for producing the cooking oil or fat composition with which it is possible to suppress the heating odor of an oil or fat produced during cooking of deep-fried foods or the like.

### Means to Solve the Problems

As a result of thoroughgoing research aimed at achieving the aforementioned object, the inventors perfected the present invention upon discovering that corn-derived roasted oil has the effect of making it possible to suppress the heating odor of an oil or fat produced during cooking of deep-fried foods or the like.

Specifically, the present invention provides a heating-odor-suppressing agent for a cooking oil or fat composition, characterized by containing corn-derived roasted oil as an active component.

The heating-odor-suppressing agent for a cooking oil or fat composition according to the present invention makes it possible to suppress the heating odor of an oil or fat produced during cooking of deep-fried foods or the like.

In the heating-odor-suppressing agent for a cooking oil or fat composition according to the present invention, the roasted oil is preferably contained in an amount of 0.01% by mass or more to 100% by mass or less.

In the heating-odor-suppressing agent, the roasted oil is preferably refined oil obtained by conducting at least a degumming process.

In the heating-odor-suppressing agent, the roasted oil is preferably derived from a raw ingredient that has been roasted at 130° C. or higher to 180° C. or lower, and furthermore is preferably derived from a raw ingredient that has been roasted for more than zero minutes to 90 minutes or less.

The heating-odor-suppressing agent is preferably for use in fried foods.

The present invention also provides a method for suppressing a heating odor in a cooking oil or fat composition, characterized in that corn-derived roasted oil is included in a cooking oil or fat composition.

The method for suppressing a heating odor in a cooking oil or fat composition according to the present invention makes it possible to suppress the heating odor of an oil or fat produced during cooking of deep-fried foods or the like.

In the method for suppressing a heating odor in a cooking oil or fat composition according to the present invention, the roasted oil is preferably included in an amount of 0.01% by mass or more to 10% by mass or less in the cooking oil or fat composition.

In the method for suppressing a heating odor, the roasted oil is preferably refined oil obtained by conducting at least a degumming process.

In the method for suppressing a heating odor, the roasted oil is preferably derived from a raw ingredient that has been roasted at 130° C. or higher to 180° C. or lower, and furthermore is preferably derived from a raw ingredient that has been roasted for more than zero minutes to 90 minutes or less.

In the method for suppressing a heating odor, the cooking oil or fat composition is preferably for use in fried foods.

The present invention furthermore provides a method for producing a cooking oil or fat composition, characterized in that the method comprises mixing corn-derived roasted oil and an edible oil or fat other than the roasted oil to thereby obtain an oil or fat composition that contains 0.01% by mass or more to 10% by mass or less of the roasted oil.

With the method for producing a cooking oil or fat composition according to the present invention, a cooking oil or fat composition obtained by said method is suitable for cooking deep-fried foods or the like and can suppress the heating odor of an oil or fat produced during such cooking.

In the method for producing a cooking oil or fat composition according to the present invention, the roasted oil is preferably refined oil obtained by conducting at least a degumming process.

In the production method, the roasted oil is preferably derived from a raw ingredient that, has been roasted at 130° C. or higher to 180° C. or lower, and furthermore is preferably derived from a raw ingredient that has been roasted for more than zero minutes to 90 minutes or less.

In the production method, the cooking oil or fat composition is preferably for use in fried foods.

### Advantageous Effects of the Invention

The present invention makes it possible to suppress the heating odor of an oil or fat produced during cooking of deep-fried foods or the like by using corn-derived roasted oil.

### BEST MODE FOR CARRYING OUT THE INVENTION

The corn-derived roasted oil used in the present invention is not subject to any particular limitation and is to be general roasted oil that can be used in foods and is obtained by roasting corn as a raw oil ingredient and then crushing, extracting, or otherwise pressing the corn. For example, it is more preferable to use corn germs, which are the germ portion of corn grains, as a raw ingredient. The corn germs used may be obtained by sorting and separating the germ portion from the corn grains according to a dry technique, i.e., may be obtained by a so-called dry milling technique, or may be obtained by sorting and separating the germ portion from the corn grains according to a wet technique, i.e., may be obtained by a so-called wet milling technique. Either of these techniques can be used, although corn germs obtained by the wet milling technique are preferred for use. Examples of the corn germs obtained by the dry milling technique include corn germs obtained as a product of a step that involves grinding corn grains. The steps involved in wet milling can, for example, be as follows. Specifically, the corn grains are first immersed for, e.g., about 48 hours in a diluted solution of sulfurous acid and are allowed to expand. At this time, the protein membrane surrounding an endosperm portion is dissolved by a type of lactic acid fermentation, consequently facilitating separation of the germ portion. The grains are then cracked in such a manner as to avoid destroying the germ portion to the extent possible, at which point the endosperm portion, which contains moisture, settles to a lower part, and the germ portion, which contains a large amount of oil content, collects at an upper part. The difference in specific gravity is therefore utilized to recover the germ portion that has collected at the upper part. The corn germs are obtained by drying the recovered germ portion. One type of corn-derived roasted oil may be used alone, or two or more types may be used in combination.

A method for roasting the corn serving as the raw oil ingredient is to be performed using a typical roasting means; for example, roasting can be suitably carried out by a roasting device provided with electric heating, hot blasting, a burner, microwaves, or other heating means. At this time, corn that has not undergone a pulverization process can be used as the corn (e.g., corn germs) that is to be a raw ingredient for roasting. As pertains to the roasting conditions, the roasting is preferably conducted at 130° C. or higher to 180° C. or lower, more preferably at 140° C. or higher to 180° C. or lower, even more preferably at 145° C. or higher to 180° C. or lower, and yet even more preferably at 150° C. or higher to 180° C. or lower. The retention time during roasting is to be set appropriately, may be such that roasting is ended at a point in time when the aforementioned temperatures are reached, and is preferably 90 minutes or less, more preferably more than zero minutes to 90 minutes or less, even more preferably 5 minutes or more to 90 minutes or less, yet even more preferably 15 minutes or more to 90 minutes or less, particularly preferably 20 minutes or more to 90 minutes or less, and even more particularly preferably 30 minutes or more to 90 minutes or less. When the roasting conditions are too mild, the effect of suppressing the heating odor tends to be insufficient; conversely, when the roasting conditions are too severe, the roasting tends to become a source that generates a burnt odor.

As the roasted oil used in the present invention, in addition to the way of using raw oil obtained by roasting corn as a raw oil ingredient and then crushing, extracting, or otherwise pressing the corn, roasted oil in the form of refined oil obtained by subjecting the raw oil to a refining process may also be used. Examples of the refining process include degumming, deacidification, bleaching, and deodorization. It is preferable to use refined oil obtained by conducting one or more refining processes from among these, and it is more preferable to use refined oil obtained by conducting at least a degumming process. Specifically, as described in the examples below, such refining processes make it possible to reduce a burnt odor originating from the roasting of the raw oil ingredient. It is also possible to remove the aroma, flavor, color, etc., of the roasted raw oil ingredient and to meet the demand in cases in which it is not preferable to have such properties from the raw ingredient.

The degumming process is a step for removing a gummy substance that has phospholipids as a main component by hydrating out from the oil content. The deacidification process is a step for performing a treatment using alkaline water or the like to thereby remove free fatty acids included in the oil content by letting them form soap components. The bleaching process is a step in which pigments included in the oil content are adsorbed out by activated clay or the like. The deodorization process is a step in which odorous components included in the oil content are removed by a treatment such as steam distillation under reduced pressure.

The heating-odor-suppressing agent for a cooking oil or fat composition according to the present invention (also occasionally referred to simply as “the heating-odor-suppressing agent” below) contains the corn-derived roasted oil described above as an active component. The agent is applied when cooking is performed using a cooking oil or fat composition, suppressing the occurrence of a heating odor. The method for suppressing a heating odor in a cooking oil or fat composition according to the present invention (also occasionally referred to simply as “the heating-odor-suppressing method” below) comprises including the corn-derived roasted oil described above in a cooking oil or fat composition and thereby suppressing a heating odor produced during cooking. As used herein, the term “heating odor” does not differ in meaning from the terminology generally understood by consumers and persons skilled in the art; specifically, the term refers to a sharp pungent odor.

In the heating-odor-suppressing agent according to the present invention, the corn-derived roasted oil is preferably contained (the total content in cases where two or more roasted oils are used) as the active component in an amount of 0.01% by mass or more to 100% by mass or less, more preferably in an amount of 0.01% by mass or more to 50% by mass or less, even more preferably in an amount of 0.1% by mass or more to 50% by mass or less, and yet even more preferably in an amount of 1% by mass or more to 50% by mass or less. Usage of such amounts makes it possible to apply the roasted oil in an effective quantity to a cooking oil or fat composition.

In the heating-odor-suppressing agent according to the present invention, components other than the corn-derived roasted oil may also be included. In this case, components that are compatible with the roasted oil and have the properties of mediums in which the roasted oil can be readily dispersed are preferred because such components make it easier to admix the agent into an oil or fat composition such as deep-fry oil and to adjust the concentration of the roasted oil. Additive-free roasted oil can also be used in certain situations as an oil or fat composition for cooking foods. Edible oil or fat are preferred as the components other than the roasted oil.

Edible oils or fats other than the corn-derived roasted oil can be suitably used as the edible oil or fat used in the present invention. Examples include: soybean oil, rapeseed oil, palm oil, corn oil, olive oil, sesame oil, safflower oil, sunflower oil, cottonseed oil, rice bran oil, peanut oil, palm kernel oil, coconut oil, and other such vegetable oils or fats; beef tallow, lard, chicken fat, and other such animal oils or fats; medium-chain fatty acid triglycerides; and processed oils or fats in which the aforementioned oils or fats are fractionated, hydrogenated, transesterified, or otherwise processed. One type of edible oil or fat may be used alone, or two or more types may be used in combination. Taking into account the ease with which a heating odor is produced, it is preferable to use, from among the aforementioned oils and fats, an edible oil or fat having blended therein in an amount of 60% by mass or more of one or more oils or fats selected from soybean oil, rapeseed oil, sunflower oil, palm olein, corn oil, having an iodine value of 50 or higher, and other such oils or fats; and it is more preferable to use an edible oil or fat having blended therein in an amount of 80% by mass or more of these oils or fats. It is also preferable to use an edible oil or fat having blended therein in an amount of 60% by mass or more of one or both oils selected from soybean oil and rapeseed oil, and it is more preferable to use an edible oil or fat having blended therein in an amount of 80% by mass or more of these.

The edible oil or fat is preferably one obtained by a process in which a raw oil obtained by crushing, extracting, or other type of pressing from a raw oil ingredient is furthermore subjected to one or more refining processes from among a degumming process, a deacidification process, a bleaching process, and a deodorization process; is more preferably one obtained in a process in which the raw oil is subjected to at least a refining deodorization process; and is even more preferably one obtained by all of the aforementioned refining processes, i.e., the degumming process, the deacidification process, the bleaching process, and the deodorization process. Such refining processes make it possible to remove the aroma, flavor, color, etc., of the raw ingredient and to meet the demand in cases in which it is not preferable to have such properties from the raw ingredient. The definitions of the degumming process, the deacidification process, the bleaching process, and the deodorization process are as set forth in the description relating to the roasted oil.

The edible oil or fat content (the total content in cases where two or more edible oils or fats are used) is preferably more than 0% by mass, more preferably 50% by mass or more, even more preferably 70% by mass or more, and yet even more preferably 80% by mass or more of the heating-odor-suppressing agent according to the present invention. No particular upper limit is established, but the total of the corn-derived roasted oil and the edible oil or fat is 100% by mass. The moisture content of the heating-odor-suppressing agent of the present invention is preferably less than 1% by mass.

An antioxidant, an emulsifier, a flavoring agent, a defoamer, and other such additive materials may also be blended in within a range that does not hinder the effect achieved by the present invention. Specific examples include fatty acid esters of ascorbic acid, lignans, coenzyme Q, y-oryzanol, tocopherol, and silicone.

Described below are preferred modes of use of the corn-derived roasted oil as an active component for suppressing a heating odor in the present invention. This does not mean, however, that the scope of the present invention is limited in any particular way to these modes of use. Specifically, irrespective of the mode of use, any agent or composition can be included in the scope of the present invention as long as agent or composition has the configuration of corn-derived roasted oil and is for specific applications such as are described above. Alternatively, any method can be included in the scope of the present invention as long as method has the configuration of corn-derived roasted oil and is used for specific applications such as are described above.

According to a preferred mode of the present invention, the corn-derived roasted oil is included in a cooking oil or fat composition used in cooking deep-fried foods, tempura, or other fried foods, as well as stir-fried foods, grilled foods, and other such foods, and the composition is applied to cooking materials or otherwise used during cooking, making it possible to suppress the heating odor produced. In this case, it is the aforementioned edible oil or fat, etc., that can be used as a base oil of the cooking oil or fat composition. The roasted oil content (the total content in cases where two or more roasted oils are used) in the cooking oil or fat composition is preferably 0.01% by mass or more to 10% by mass or less, more preferably 0.03% by mass or more to 10% by mass or less, even more preferably 0.03% by mass or more to 5% by mass or less, yet even more preferably 0.1% by mass or more to 5% by mass or less, and particularly preferably 0.3% by mass or more to 5% by mass or less. Such usage makes it possible to apply the corn-derived roasted oil in an effective quantity when cooking is performed using the cooking oil or fat composition, and also to meet the demand in cases where the aroma, flavor, color, and other such properties of the roasted oil are not preferred.

The present invention can preferably be applied to cooked foods comprising tempura, French fries, hash browns, croquettes, deep-fried meat and fish, fried pork cutlets, fried fish, corn dogs, chicken nuggets, fried tofu, doughnuts, fried dough, croutons, fried rice crackers, snack foods, instant ramen, and other such fried foods. Alternatively, the present invention can preferably also be applied to: cooked foods comprising stir-fried vegetables, stir-fried liver, stir-fried garlic chives, stir-fried bean sprouts, and other such stir-fried foods; and cooked foods comprising hamburg steaks, pot stickers, fried eggs, and other such grilled foods.

In particular, there are many cases where oils for fried foods are used in cooking over extended periods, not only in household use but also in industrial use, and these oils are products to which the present invention can be applied more preferably. The modes for preparing cooked foods are not subject to any particular limitation, and cooking is to be conducted in the present invention in an appropriate manner in accordance with the desired mode by methods suitable for a variety of cooked foods in accordance with the type of cooked food, using the corn-derived roasted oil as an active component for suppressing the heating odor. Specifically, the corn-derived roasted oil, or the heating-odor-suppressing agent containing the corn-derived roasted oil or the cooking oil or fat composition containing the corn-derived roasted oil, is to be used to fry, stir-fry, grill, or otherwise cook prescribed preparation materials for a cooked food under conditions in which the temperature is typically set to 140 to 200° C., and is more typically set to 150 to 190° C.

### EXAMPLES

The present invention is described in greater detail below by way of examples, but these examples do not in any way limit the present invention.

(Roasted Oil)

Table 1 shows the roasted oils used.

TABLE 1

| | Raw | Roasting conditions and |
|---|---|---|
| | ingredient | oil pressing method |
| Roasted | Soybeans | Unprocessed soybeans were |
| soybean oil | | roasted for 30 min |
| | | at 150° C. and then crushed. |
| Roasted | Rapeseed | Unprocessed rapeseed was |
| rapeseed oil | | roasted for 30 min at |
| | | 150° C. and then crushed. |
| Roasted | Cottonseed | Cottonseed was pulverized by |
| cottonseed | | hitting with a hammer, subsequently |
| oil | | roasted for 30 min at 150° C, |
| | | and then extracted using hexane. |
| Roasted | Sesame | Commercial roasted sesame oil |
| sesame oil | | (product name ″Gomasuki no gomayu,″ |
| | | made by J-Oil Mills inc.; |
| | | roasted sesame was crushed). |
| Roasted corn | Corn germs | Corn germs obtained by |
| oil (W) | (wet) | wet milling were roasted for |
| | | 30 min at 150° C and then crushed. |
| Roasted corn | Corn germs | Corn germs obtained by |
| oil (D) | (dry) | dry milling were roasted for 30 min |
| | | at 150° C. and then crushed. |

The roasting was conducted using a roasting device provided with a gas burner as a heating means.

In addition to raw oils crushed or extracted from the raw oil ingredients, optionally refined oils or fats were furthermore prepared as roasted oils, as shown in table 2.

TABLE 2

| | | Refining steps | | | | |
|---|---|---|---|---|---|---|
| | Refining | Crushing/ | | | | |
| | state | extraction | Degumming | Deacidification | Bleaching | Deodorization |
| Roasted | Pressed | ◯ | — | — | — | — |
| soybean oil | Degummed | ◯ | ◯ | — | — | — |
| | Deacidified | ◯ | ◯ | ◯ | — | — |
| | Bleached | ◯ | ◯ | ◯ | ◯ | — |
| | Deodorized | ◯ | ◯ | ◯ | ◯ | ◯ |
| Roasted | Pressed | ◯ | — | — | — | — |
| rapeseed oil | Degummed | ◯ | ◯ | — | — | — |
| Roasted | Pressed | ◯ | — | — | — | — |
| cottonseed oil | Degummed | ◯ | ◯ | — | — | — |
| Roasted | Pressed | ◯ | — | — | — | — |
| sesame oil | Degummed | ◯ | ◯ | — | — | — |
| Roasted | Pressed | ◯ | — | — | — | — |
| corn oil | Degummed | ◯ | ◯ | — | — | — |
| (W) | Deacidified | ◯ | ◯ | ◯ | — | — |
| | Bleached | ◯ | ◯ | ◯ | ◯ | — |
| | Deodorized | ◯ | ◯ | ◯ | ◯ | ◯ |
| Roasted | Deodorized | ◯ | ◯ | ◯ | ◯ | ◯ |
| corn oil (D) | | | | | | |

(The “◯” symbols indicate how far refinement has progressed in the preparation of roasted oils.)

(Evaluation)

Conditions such as those employed in extended heating in an industral application were simulated, 700 q of test oil was heated for five hours at 180° C., and then the heating odor and burnt odor of the test oils were evaluated. The evaluations were conducted by two expert panelists who followed the evaluation criteria given below and made comparisons with a base oil to which no roasted oil was added. The two panelists assigned scores after reaching an agreement.

<Evaluation of heating odor>

5: Heating odor greatly suppressed

4: Heating odor suppressed

3: Heating odor somewhat suppressed

2: Heating odor barely suppressed

1: Heating odor equal or stronger

<Evaluation of burnt odor>

5: Burnt odor very weak or imperceptible

4: Burnt odor weak

3: Burnt odor somewhat weak

2: Burnt odor strong

1: Burnt odor very strong

### Test Example 1

An oil in which 3 ppm of silicone was included as a defoamer in canola oil (manufactured by J-Oil Mills Inc.; subjected to a degumming process, a deacidification process, a bleaching process, and a deodorization process; same below) was used as a base oil, and the roasted oils described above were added to the base oil so as to reach a concentration of 0.3% by mass, thus forming test oils. The heating odor and burnt odor were evaluated.

The results are shown in table 3.

TABLE 3
Base oil: canola oil (with silicone added)

| | | | Evaluation | (score) |
|---|---|---|---|---|
| | Roasted oil added | Refining | Heating | Burnt |
| | (0.3% by mass) | state | odor | odor |
| Example 1 | Roasted corn oil (W) | Pressed | 5 | 1 |
| Example 2 | (corn germ (wet)) | Degummed | 5 | 3 |
| Example 3 | | Deacidified | 5 | 3 |
| Example 4 | | Bleached | 5 | 4 |
| Example 5 | | Deodorized | 5 | 5 |
| Comparative | Roasted soybean oil | Pressed | 3 | 1 |
| example 1 | | | | |
| Comparative | | Degummed | 3 | 1 |
| example 2 | | | | |
| Comparative | | Deacidified | 3 | 3 |
| example 3 | | | | |
| Comparative | | Bleached | 3 | 3 |
| example 4 | | | | |
| Comparative | | Deodorized | 3 | 5 |
| example 5 | | | | |
| Comparative | Roasted rapeseed oil | Pressed | 2 | 1 |
| example 6 | | | | |
| Comparative | | Degummed | 2 | 1 |
| example 7 | | | | |
| Comparative | Roasted sesame oil | Pressed | 2 | 1 |
| example 8 | | | | |
| Comparative | | Degummed | 2 | 1 |
| example 9 | | | | |
| Comparative | Roasted cottonseed oil | Pressed | 1 | 1 |
| example 10 | | | | |
| Comparative | | Degummed | 1 | 1 |
| example 11 | | | | |

As a result, the heating odor was markedly suppressed in examples 1 to 5, in which roasted corn oil was blended into canola oil. By contrast, in test oils in which roasted soybean oil was blended (comparative examples 1 to 5), test oils in which roasted rapeseed oil was blended (comparative examples 6 and 7), test oils in which roasted sesame oil was blended (comparative examples 8 and 9), and test oils in which roasted cottonseed oil was blended (comparative examples 10 and 11), the effect of suppressing the heating odor was limited or virtually absent.

As can be observed from the results of examples 2 to 5, it is apparent that when the roasted corn oil is in the form of refined oil obtained by conducting at least a degumming process, the burnt odor is further reduced than when the roasted corn oil is in the pressed form obtained by crushing alone (example 1), while the effect of suppressing the heating odor remains unchanged.

### Test example 2

An oil in which 3 ppm of silicone was included as a defoamer in canola oil was used as a base oil, and the roasted corn oil (W) (corn germs (wet)) (refining state: deodorized) described above was added to the base oil so as to reach a concentration of 0.03% by mass, 0.3% by mass, 0.5% by mass, 1% by mass, 3% by mass, or 5% by mass, thus forming test oils. The heating odor and burnt odor were evaluated. The evaluations were conducted as described above.

The results are shown in table 4.

TABLE 4
Base oil: danola oil (with silicone added)

| | | | Evaluation (score) | |
|---|---|---|---|---|
| | | | Heating | Burnt |
| | Roasted oil added | Concentration | odor | odor |
| Example 6 | Roasted corn oil (W) | 0.03% by mass | 4 | 5 |
| Example 7 | (corn germs (wet)) | 0.3% by mass | 5 | 5 |
| Example 8 | Refining state: | 0.5% by mass | 5 | 5 |
| Example 9 | deodorized | 1% by mass | 5 | 5 |
| Example 10 | | 3% by mass | 5 | 5 |
| Example 11 | | 5% by mass | 5 | 5 |

As a result, the effect of suppressing the heating odor was observed when the corn oil was blended in an amount of 0.03% or higher, and the effect was notable when the blending amount was 0.3 to 5% by mass, as can be observed from the results of examples 6 to 11.

### Test Example 3

Canola oil was used as the base oil, the roasted corn oil (W) (refining state: deodorzed) described above was added to the base oil so as to reach a concentration of 0.3% by mass, thus forming a test oil, and the heating odor and burnt odor were evaluated. The evaluations were conducted as described above.

The results are shown in table 5.

TABLE 5
Base oil: canola oil (silicone-free)

| | | | Evaluation (score) | |
|---|---|---|---|---|
| | Roasted oil added | Refining | Heating | Burnt |
| | (0.3% by mass) | state | odor | odor |
| Example 12 | Roasted corn oil (W) | Deodorized | 5 | 5 |
| | (corn germs (Wet)) | | | |

As a result, in the same manner as in the cases shown in test examples 1 and 2 where silicone-containing canola oil was used as a base oil, a heating-odor-suppressing effect derived from the roasted corn oil was also observed in a case where silicone-free canola oil was used as a base oil.

### Test Example 4

A mixed oil obtained by mixing 50 parts by mass of canola oil and 50 parts by mass of soybean oil (manufactured by J-Oil Mills Inc.; subjected to a degumming process, a deacidification process, a bleaching process, and a deodorization process) was used as a base oil, the roasted corn oil (W) (refining state: deodorized) described above was added to the base oil so as to reach a concentration of 0.3% by mass, thus forming a test oil, and the heating odor and burnt odor were evaluated. The evaluations were conducted as described above.

The results are shown in table 6.

TABLE 6
Base oil: canola oil/soybean oil = 50/50

| | | | Evaluation (score) | |
|---|---|---|---|---|
| | Roasted oil added | Refining | Heating | Burnt |
| | (0.3% by mass) | state | odor | odor |
| Example 13 | Roasted corn oil (W) | Deodorized | 5 | 5 |
| | (corn germs (wet)) | | | |

As a result, in the same manner as in the cases shown in test examples 1 to 3 where canola oil was used as a base oil, a heating-odor-suppressing effect derived from the roasted corn oil was also observed in a case where a mixed oil of canola oil and soybean oil was used as a base oil.

### Test Example 5

A mixed oil of roasted corn oil was prepared as a roasted oil by mixing 80 parts by mass of the roasted corn oil (W) (refining state: deodorized) described above and 20 parts by mass of roasted corn oil (D) (refining state: deodorized).

An oil in which 3 ppm of silicone was included as a defoamer in canola oil was used as a base oil, and the mixed oil of roasted corn oil (refining state: deodorized) described above was added to the base oil so as to reach a concentration of 1% by mass, 3% by mass, or 5% by mass, thus forming test oils. The heating odor and burnt odor were evaluated. The evaluations were conducted as described above.

The results are shown in table 7.

TABLE 7
Base oil: canola oil (with silicone added)

| | | | Evaluation (score) | |
|---|---|---|---|---|
| | Roasted oil added | | Heating | Burnt |
| | (0.3% by mass) | Concentration | odor | odor |
| Example 14 | Roasted corn oil | 1% by mass | 4 | 5 |
| Example 15 | (W)/roasted corn oil | 3% by mass | 4 | 5 |
| Example 16 | (ID) = 80/20 | 5% by mass | 4 | 5 |
| | Refining state: | | | |
| | deodorized | | | |

As a result, in the same manner as in the cases where a roasted oil derived from corn germs obtained by wet milling was used alone, a heating-odor-suppressing effect was also observed in a case where a roasted oil derived from corn germs obtained by dry milling was used in combination, as can be observed from the results of examples 14 to 16.

### Test Example 6

In lieu of the roasted corn oil (W) described above, i.e., the roasted oil (refining state: pressed) obtained by roasting wet-milled corn germs for 30 minutes at 150° C. and then crushing the corn germs, roasted corn oils (W) (refining state: pressed) obtained by arbitrarily varying the roasting conditions as shown in table 8 were used as roasted oils.

An oil in which 3 ppm of silicone was included as a defoamer in canola oil was used as a base oil, and the roasted corn oils (W) (refining state: pressed) described above were added to the base oil so as to reach a concentration of 0.3% by mass, thus forming test oils. The heating odor and burnt odor were otherwise evaluated in the same manner as in test example 1. The evaluations were conducted as described above. For the sake of comparison, tests were also conducted in the same manner on corn oil (refining state: pressed) that was obtained from wet-milled corn germs by crushing the corn germs without conducting a roasting process.

The results are shown in table 8.

TABLE 8
Base oil: canola oil (with silicone added)

| | Roasted | | | Evaluation (score) | |
|---|---|---|---|---|---|
| | oil added | Roasting | Roasting | Heating | Burnt |
| | (0.3% by mass) | temperature | time | odor | odor |
| Comparative | Roasted corn | — | — | 1 | 5 |
| example 12 | oil (W) obtained | | | | |
| Example 17 | under various | 150° C. | 15 min | 4 | 1 |
| Example 10 | roasting | | 30 min | 5 | 1 |
| Example 19 | conditions | | 60 min | 5 | 1 |
| Example 20 | Refining state: | | 90 min | 5 | 1 |
| Example 21 | pressed. | 180° C. | 30 min | 5 | 1 |
| Example 22 | | | 60 min | 5 | 1 |
| Example 23 | | | 90 min | 5 | 1 |

As a result, as shown in the results of comparative example 12, no effect of suppressing the heating odor was obtained when the raw oil ingredient was not roasted. On the other hand, as can be observed from the results of examples 17 to 23, the effect of suppressing the heating odor was sufficiently obtained by conducting roasting for at least 15 minutes at a temperature of at least 150° C.

### Test Example 7

The test oil described in example 5 was used to prepare fried foods as described below.

(1) Deep-fried flour batter: Tempura batter mix (product name “Kotsu no iranai tempurako,” manufactured by Nisshin Foods Inc.) was used to prepare a batter, and the batter was fried for three minutes at 170° C.

(2) Fish fingers: Frozen fish fingers (manufactured by Yachiyo Corp.) were fried for three minutes at 170° C.

(3) Croquettes: Frozen croquettes (product name “NEW potato korokke,” manufactured by Ajinomoto Frozen Food Co., Inc.) were fried for three minutes at 170° C.

(4) Croutons: Sandwich bread (product name “Chojuku sandwich yo,” manufactured by Pasco Shikishima Corp.) was diced to a size of about 2 cm per side, and the diced bread was fried for 20 seconds at 170° C.

### Test Example 8

An oil in which 3 ppm of silicone was included as a defoamer in canola oil was used as a base oil, and the roasted corn oil (W) (corn germs (wet)) (refining state: deodorized) described above was added to the base oil so as to reach a concentration of 0.4% by mass, thus forming a test oil. An oil in which 3 ppm of silicone was included as a defoamer in canola oil was used as a control oil.

700 g of each of the test oil and the control oil were heated to 180° C. and evaluated for heating odors. The evaluations were conducted by expert panelists in the numbers shown in table 9. The evaluations were conducted immediately after the oils were heated to 180° C. and 32 hours after the oils were heated to 180° C. The panelists assigned scores in six levels in accordance with the evaluation criteria given below. The average score and the standard deviation of the assigned scores were calculated, and a significance test was furthermore conducted according to the Wilcoxon test. The evaluations were conducted by preparing the test oil and the control oil separately for the test groups in which the oils were evaluated immediately after being heated to 180° C. and 32 hours after being heated to 180° C. In an evaluation in which the oils were heated for 32 hours at 180° C., a control oil heated to 180° C. was separately prepared and used in a comparative evaluation immediately after being heated.

(Evaluation Criteria)

5: Heating odor perceived as being much stronger than that immediately after control oil was heated to 180° C.

4: Heating odor perceived as being stronger than that immediately after control oil was heated to 180° C.

3: Heating odor perceived as being equal to that immediately after control oil was heated to 180° C.

2: Heating odor perceived as being somewhat weaker than that immediately after control oil was heated to 180° C.

1: Heating odor perceived as being weaker than that immediately after control oil was heated to 180° C.

0: No discernible heating odor

The results are shown in table 9.

TABLE 9
Base oil: canola oil (with silicone added)

| | Roasted | | | | No. of | Evaluation | |
|---|---|---|---|---|---|---|---|
| | oil added | Presence of | Oil or | Evaluation | expert | Average | Standard |
| | (0.4% by mass) | additive | fat used | period | panelists | score | deviation |
| Comparative | Roasted corn oil | − | Control oil | Immediately | 11 | 3 | 0 |
| example 13 | (W) (corn germs | | | after heating | | | |
| Example 24 | (wet)) Refining | + | Test oil | to 180° C. | | 2.27 | 0.41 |
| Comparative | state: deodorized | − | Control oil | 32 hours | 6 | 3.50 | 0.45 |
| example 14 | | | | after heating | | | |
| Example 25 | | + | Test oil | to 180° C. | | 2.67 | 0.52 |

As a result, the heating odor was suppressed when the roasted corn oil was added in cases where the oils were evaluated at along the same evaluation period. According to the results of the significance test, the level of significance between example 24 and comparative example 13 was 5%, and thus there was a significant difference between the two oils. The level of significance between example 25 and comparative example 14 was also 5%, and thus there was a significant difference here as well.

1. A heating-odor-suppressing agent for a cooking oil or fat composition, characterized by containing corn-derived roasted oil as an active component.

2. The heating-odor-suppressing agent for a cooking oil or fat composition according to claim 1, wherein the roasted oil is contained in an amount of 0.01% by mass or more to 100% by mass or less.

3. The heating-odor-suppressing agent for a cooking oil or fat composition according to claim 1, wherein the roasted oil is refined oil obtained by conducting at least a degumming process.

4. The heating-odor-suppressing agent for a cooking oil or fat composition according to claim 1, wherein the roasted oil is derived from a raw ingredient that has been roasted at 130° C. or higher to 180° C. or lower.

5. The heating-odor-suppressing agent for a cooking oil or fat composition according to claim 4, wherein the roasted oil is derived from a raw ingredient that has been roasted for more than zero minutes to 90 minutes or less.

6. The heating-odor-suppressing agent for a cooking oil or fat composition according to claim 1, for use in fried foods.

7. A method for suppressing a heating odor in a cooking oil or fat composition, characterized in that corn-derived roasted oil is included in a cooking oil or fat composition.

8. The method for suppressing a heating odor in a cooking oil or fat composition according to claim 7, wherein the roasted oil is included in an amount of 0.01% by mass or more to 10% by mass or less in the cooking oil or fat composition.

9. The method for suppressing a heating odor in a cooking oil or fat composition according to claim 7, wherein the roasted oil is refined oil obtained by conducting at least a degumming process.

10. The method for suppressing a heating odor in a cooking oil or fat composition according to claim 7, wherein the roasted oil is derived from a raw ingredient that has been roasted at 130° C. or higher to 180° C. or lower.

11. The method for suppressing a heating odor in a cooking oil or fat composition according to claim 10, wherein the roasted oil is derived from a raw ingredient that has been roasted for more than zero minutes to 90 minutes or less.

12. The method for suppressing a heating odor in a cooking oil or fat composition according to claim 7, wherein the cooking oil or fat composition is for use in fried foods.

13. A method for producing a cooking oil or fat composition, characterized in that the method comprises mixing corn-derived roasted oil and an edible oil or fat other than the roasted oil to thereby obtain an oil or fat composition that contains 0.01% by mass or more to 10% by mass or less of the roasted oil.

14. The method for producing a cooking oil or fat composition according to claim 13, wherein the roasted oil is refined oil obtained by conducting at least a degumming process.

15. The method for producing a cooking oil or fat composition according to claim 13, wherein the roasted oil is derived from a raw ingredient that has been roasted at 130° C. or higher to 180° C. or lower.

16. The method for producing a cooking oil or fat composition according to claim 15, wherein the roasted oil is derived from a raw ingredient that has been roasted for more than zero minutes to 90 minutes or less.

17. The method for producing a cooking oil or fat composition according to claim 13, wherein the cooking oil or fat composition is for use in fried foods.
